(19) United States
(12) Patent Application Publication
(10) Pub. No.: US 2025/0199549 A1
(43) Pub. Date: Jun. 19, 2025

(54) IRRIGATION VALVE MANAGEMENT DEVICE

(71) Applicants: Marcelo Anbank Galis, Wylie, TX (US); Marcos Galis, Wylie, TX (US)

(72) Inventors: Marcelo Anbank Galis, Wylie, TX (US); Marcos Galis, Wylie, TX (US)

(21) Appl. No.: 19/063,489

(22) Filed: Feb. 26, 2025

Related U.S. Application Data
(63) Continuation of application No. 18/929,135, filed on Oct. 28, 2024.
Application No. 18/929,135 is a continuation of application No. 18/439,404, filed on Feb. 12, 2024, now abandoned.
(60) Provisional application No. 63/536,225, filed on Sep. 1, 2023.

(51) Int. Cl. G05D 7/06

(52) U.S. Cl. CPC G05D 7/0623

(57) ABSTRACT

An irrigation valve management device is designed to facilitate the operation of multiple irrigation valves using a single field wire. This device includes a housing containing valve actuation circuitry, an input for receiving control signals from a controller unit, and multiple outputs. Each output is connected to a signal routing component, allowing controlled signal flow to individual irrigation valves. The device, as part of an irrigation valve management system, works in conjunction with a controller unit and an additional valve management device per additional valve. The system enables efficient and simplified control of multiple valves, reducing the complexity and cost associated with traditional irrigation systems.

### CROSS-REFERENCE TO RELATED APPLICATIONS

This application is a continuation of U.S. Provisional Application No. 63/536,225, filed on Sep. 1, 2023, which is hereby incorporated by reference in its entirety.

### BACKGROUND

### 1. Field of the Invention

The present invention relates generally to irrigation control systems, and more specifically to an apparatus for the management and operation of multiple irrigation valves through a simplified wiring protocol.

### 2. Description of Related Art

Irrigation systems are well known in the art and are effective means to manage the watering of agricultural and landscaping areas. For example, conventional irrigation systems typically have multiple control wires configured to operate individual valves for water distribution.

One of the problems commonly associated with conventional irrigation systems is the complexity and cost of installing and maintaining an extensive wiring network. For example, conventional systems require a dedicated control wire for each valve, which complicates the addition of new valves or the repair of existing ones. This traditional approach may not only necessitate digging new trenches or adding new wiring to existing ones, but also compounds troubleshooting difficulties and the potential for system failures due to wire degradation or connection issues.

Accordingly, although great strides have been made in the area of irrigation control technologies, many shortcomings remain. It is therefore an object of the present invention to provide an irrigation valve management device that simplifies the wiring system by enabling the independent control of multiple valves with a single field wire, thereby reducing material and labor costs associated with system installation and expansion.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of a preferred embodiment of the irrigation valve management device of the present application;

FIG. 2 is a general schematic diagram of the irrigation valve management device according to a preferred embodiment of the present application;

FIG. 3 is a general schematic diagram of an irrigation valve management system according to a preferred embodiment of the present application;

FIG. 4 is an exemplary circuit diagram of the irrigation valve management system according to a preferred embodiment of the present application; and

FIG. 5 is a methodology for managing irrigation valves using the device and system of FIGS. 1-4.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional irrigation control systems. Specifically, the system of the present invention simplifies the wiring required for valve operation, enabling the control of multiple valves through a single field wire. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

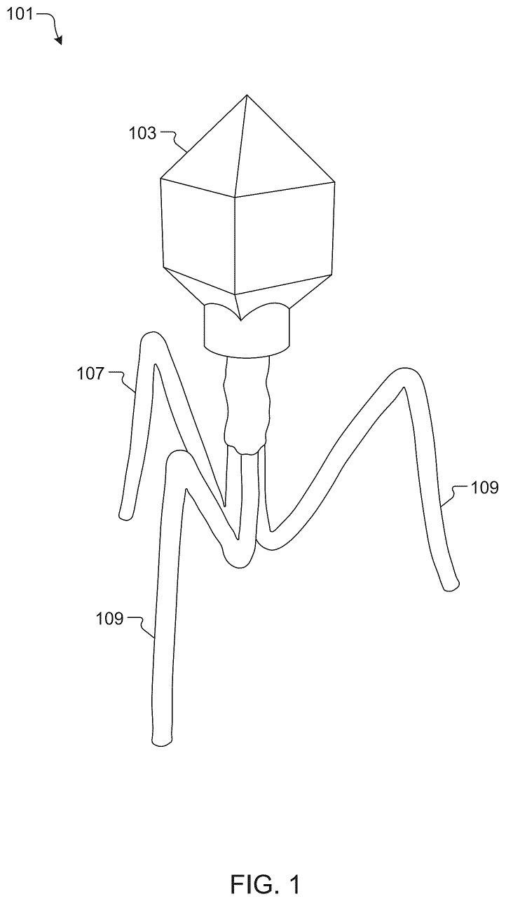

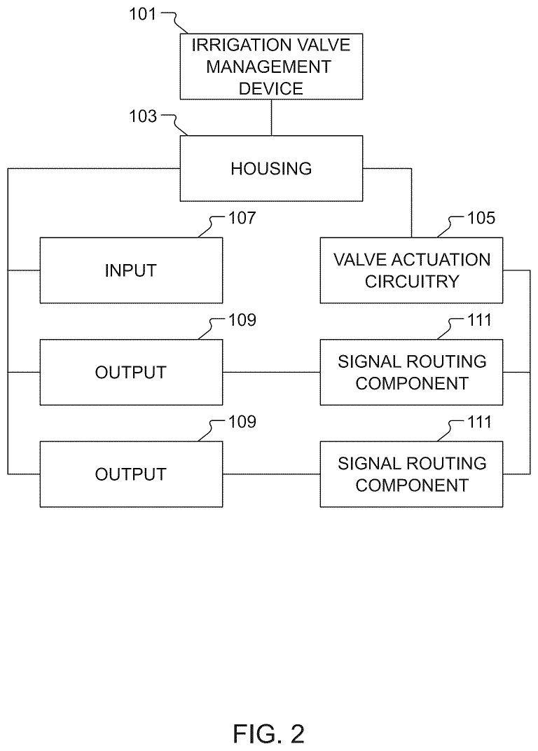

Referring now to the drawings wherein like reference characters identify corresponding or similar elements throughout the several views, FIGS. 1-2 depict an exemplary perspective view and a schematic view of an irrigation valve management device 101 in accordance with a preferred embodiment of the present application. It will be appreciated that irrigation valve management device 101 overcomes one or more of the above-listed problems commonly associated with conventional irrigation valve control systems. In addition, it should be appreciated that more or fewer of such components may be included in different embodiments of the irrigation valve management device 101. In some embodiments the irrigation valve management device 101 may be referred to by the brand name “Wirevirus.”

In the contemplated embodiment, the irrigation valve management device 101 comprises a housing 103 configured to contain valve actuation circuitry 105, an input 107 configured to receive and transmit a control signal from a controller unit to the circuitry, and a plurality of outputs 109. Each output 109 is connected to a respective signal routing component 111 of the valve actuation circuitry 105, wherein each output 109 is configured to enable controlled signal flow to a corresponding irrigation valve from a plurality of irrigation valves. It may be noted, however, that the input 107 and outputs 109 may not necessarily be restricted to said functions, and may be functionally mirrored, or generalized together as a plurality of connections that may in different embodiments and/or use cases be functionally interchangeable or intermingled with one another in various configurations as suitable.

The housing 103 may vary in different embodiments. Preferably, the housing 103 has a geometry shaped to appear similar to the head of a virus, though this is mainly aesthetic and does not play a functional role. The housing 103 may be manufactured through various means. In some embodiments, the housing 103 may be made through an additive manufacturing process, such as 3-D printing, though any suitable manufacturing process may be utilized. Further, the housing 103 should be made from a durable, waterproof material to provide a robust and protective environment for the electronic components contained within, ensuring a long operation life.

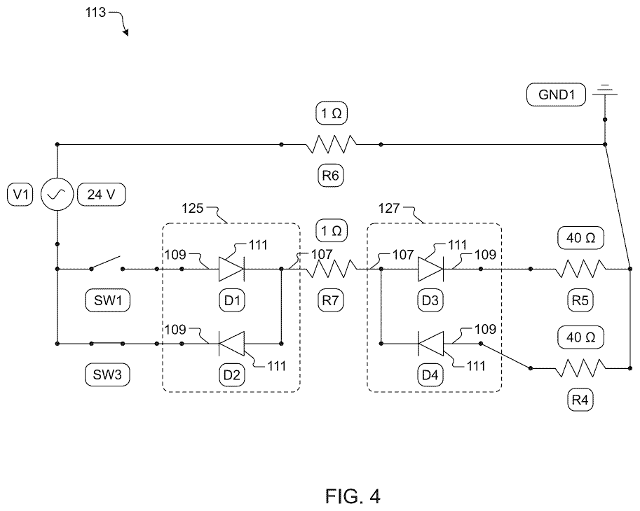

In the contemplated embodiment, the signal routing components 111 are diodes, as shown in FIG. 4. The diodes enable the controlled signal flow to the correct corresponding valves. The use of diodes as signal routing components 111 is configured to ensure unidirectional flow of the control signals to facilitate accurate and independent control of each valve.

In some embodiments, the device may include color-coded inputs 107 and outputs 109, wherein the input 107 and each of the plurality of outputs 109 is colored dissimilar to each other. This feature is intended to aid in the identification of connections, simplifying the installation process and aiding in maintenance and troubleshooting.

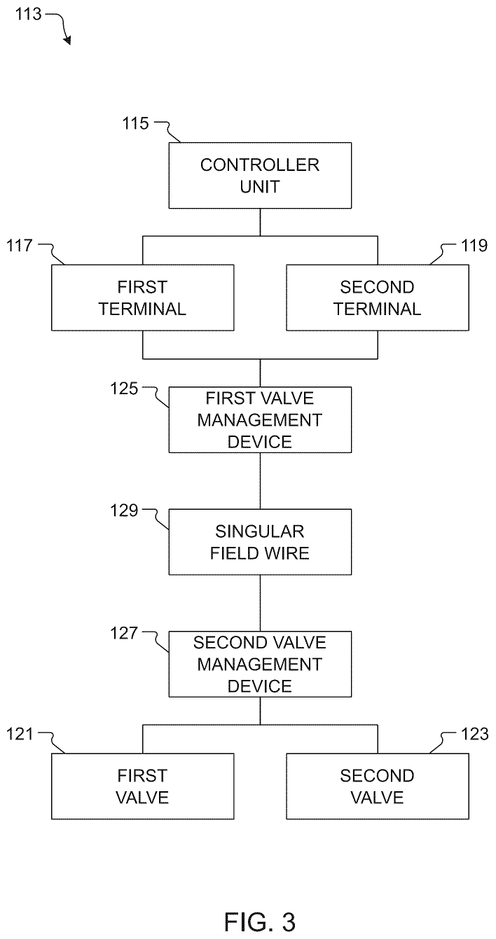

Referring to FIG. 3, in an irrigation valve management system 113 utilizing the irrigation valve management device 101, a controller unit 115 is comprised. The controller unit 115 has a first terminal 117 and a second terminal 119, and is configured to send valve actuation signals through the terminals to respectively control a first valve 121 and a second valve 123. Further, a first valve management device 125 and a second valve management device 127, as previously described, are included in the herein described system 113. It is contemplated and will be appreciated that although the system 113 is described as having two valves, two valve management devices 101, and two controller terminals, it should be understood to be an exemplary system embodiment and may be generalized without limit.

The first valve management device 125 is connected to the first terminal 117 and second terminal 119 of the controller unit 115, and is configured to receive the valve actuation signals therethrough and route the actuation signals through a singular field wire 129. Correspondingly, the second valve management device 127 is connected to the first valve 121 and the second valve 123, and is configured to receive the actuation signals through the singular field wire 129 and subsequently route the actuation signals from the first terminal 117 to the first valve 121 and from the second terminal 119 to the second valve 123. This routing of signals is preferably accomplished through the inclusion of diodes as the signal routing components 111 according to the preceding disclosure. Therefore, the first valve management device 125 and the second valve management device 127 enable controlled operation of the first valve 121 and the second valve 123 by the controller unit 115 through the singular field wire 129.

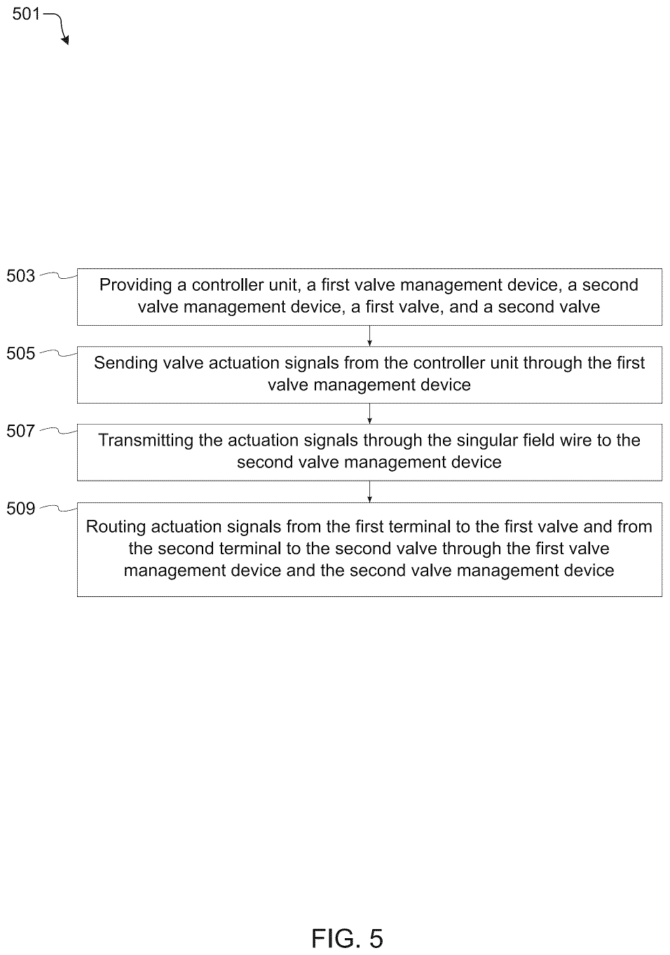

FIG. 5 depicts a method of use 501 for the device and system of FIGS. 1-4 in accordance with an embodiment of the present invention. The method 501 initiates with step 503 of providing a controller unit, a first valve management device, a second valve management device, a first valve, and a second valve as previously described, wherein the first valve management device is connected between a first terminal and a second terminal of the controller unit and a singular field wire, and wherein the second valve management device is connected between the singular field wire and the first valve and second valve.

The method 501 further includes a step 505 of sending valve actuation signals from the controller unit through the first valve management device. In step 507, the actuation signals are transmitted through the singular field wire to the second valve management device. Finally, in step 509, the actuation signals are routed from the first terminal to the first valve and from the second terminal to the second valve through the first valve management device and the second management device, wherein controlled operation of the first valve and the second valve by the controller unit is enabled via the singular field wire by the first valve management device and the second valve management device.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An irrigation valve management device comprising:
a housing configured to contain valve actuation circuitry;
an input configured to receive and transmit a control signal from a controller unit to the circuitry; and
a plurality of outputs, each connected to a respective signal routing component of the valve actuation circuitry, wherein each output is configured to enable controlled signal flow to a corresponding irrigation valve from a plurality of irrigation valves.

2. The invention of claim 1, wherein the housing is waterproof.

3. The invention of claim 1, wherein each of the signal routing components is a diode.

4. The invention of claim 1, wherein the input and each of the plurality of outputs are colored dissimilar to each other.

5. An irrigation valve management system, comprising:
a controller unit with a first terminal and a second terminal, configured to send valve actuation signals through the terminals to respectively control a first valve and a second valve;
a first valve management device, configured to receive the valve actuation signals and route the actuation signals through a singular field wire; and
a second valve management device connected to the first valve and the second valve, configured to receive the actuation signals through the singular field wire and route the actuation signals from the first terminal to the first valve and from the second terminal to the second valve;
wherein the first valve management device and the second valve management device enable controlled operation of the first valve and second valve by the controller unit through the singular field wire.

6. A method for managing irrigation valves, the method comprising the steps of:
providing a controller unit, a first valve management device, a second valve management device, a first valve, and a second valve,
wherein the first valve management device is connected between a first terminal and a second terminal of the controller unit and a singular field wire, and
wherein the second valve management device is connected between the singular field wire and the first valve and second valve;
sending valve actuation signals from the controller unit through the first valve management device;
transmitting the actuation signals through the singular field wire to the second valve management device; and
routing actuation signals from the first terminal to the first valve and from the second terminal to the second valve through the first valve management device and the second valve management device,
wherein controlled operation of the first valve and the second valve by the controller unit is enabled via the singular field wire by the first valve management device and the second valve management device.
